(19) United States
(12) Patent Application Publication
(10) Pub. No.: US 2012/0078822 A1
(43) Pub. Date: Mar. 29, 2012

(54) METHOD AND APPARATUS FOR PROVIDING A FRAMEWORK FOR GENERATING RECOMMEDATION MODELS

(75) Inventors: Sailesh Kumar Sathish, Tampere (FI); Jari P. Hamalainen, Kangasala (FI)

(73) Assignee: Nokia Corporation, Espoo (FI)

(21) Appl. No.: 12/892,506

(22) Filed: Sep. 28, 2010

(51) Int. Cl. G06N 5/02; G06F 15/18

(52) U.S. Cl. 706/12; 706/46

(57) ABSTRACT

An approach is provided for providing a framework for generating recommendation models. A recommendation engine receives a request, at the recommendation engine, for generating a recommendation model for an application, wherein the recommendation engine is applicable to a plurality of applications. Next, the recommendation engine determines to retrieve rating information from on one or more profiles associated with the application, one or more other applications, or a combination thereof. Then, the recommendation engine determines to generate the recommendation model based, at least in part, on the rating information.

### BACKGROUND

Service providers and device manufacturers (e.g., wireless, cellular, etc.) are continually challenged to deliver value and convenience to consumers by, for example, providing compelling network services. One area of development has been the use of recommendation systems to provide users with suggestions or recommendations for content, items, etc. available within the services and/or related applications (e.g., recommendations regarding people, places, or things of interest such as companions, restaurants, stores, vacations, movies, video on demand, books, songs, software, articles, news, images, etc.). For example, a typical recommendation system may suggest an item to a user based on a prediction that the user would be interested in the item—even if that user has never considered the item before—by comparing the user's preferences to one or more reference characteristics. However, such recommendation systems historically have been developed on an application by application or service by service basis. In other words, typically each application or service has a separate recommendation system or engine to develop recommendation models tailored specifically for the respective application. This traditional approach can be resource intensive because the recommendation systems or models are often complex and data intensive. Accordingly, service providers and device manufacturers face significant technical challenges to enabling development and generation of recommendation systems and models.

### SOME EXAMPLE EMBODIMENTS

Therefore, there is a need for an approach for providing a framework for generating recommendation models for multiple applications or services.

According to one embodiment, a method comprises receiving a request, at a recommendation engine, for generating a recommendation model for an application, wherein the recommendation engine is applicable to a plurality of applications. The method also comprises determining to retrieve rating information from on one or more profiles associated with the application, one or more other applications, or a combination thereof. The method further comprises determining to generate the recommendation model based, at least in part, on the rating information.

According to another embodiment, an apparatus comprises at least one processor, and at least one memory including computer program code, the at least one memory and the computer program code configured to, with the at least one processor, cause, at least in part, the apparatus to receive a request, at a recommendation engine, for generating a content recommendation model for an application, wherein the recommendation engine is applicable to a plurality of applications. The apparatus is also caused to determine to retrieve content rating information from on one or more profiles associated with the application, one or more other applications, or a combination thereof. The apparatus is further caused to determine to generate the content recommendation model based, at least in part, on the content rating information.

According to another embodiment, a computer-readable storage medium carries one or more sequences of one or more instructions which, when executed by one or more processors, cause, at least in part, an apparatus to receive a request, at a recommendation engine, for generating a content recommendation model for an application, wherein the recommendation engine is applicable to a plurality of applications. The apparatus is also caused to determine to retrieve content rating information from on one or more profiles associated with the application, one or more other applications, or a combination thereof. The apparatus is further caused to determine to generate the content recommendation model based, at least in part, on the content rating information.

According to another embodiment, an apparatus comprises means for receiving a request, at a recommendation engine, for generating a content recommendation model for an application, wherein the recommendation engine is applicable to a plurality of applications. The apparatus also comprises means for determining to retrieve content rating information from on one or more profiles associated with the application, one or more other applications, or a combination thereof. The apparatus further comprises means for determining to generate the content recommendation model based, at least in part, on the content rating information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a framework for generating recommendation models, according to one embodiment;

FIG. 2 is a diagram of the components of a recommendation engine, according to one embodiment;

FIG. 3 is a flowchart of a process for providing a framework for generating recommendation models, according to one embodiment;

FIG. 4 is a diagram demonstrating the processes of FIG. 3, according to one embodiment;

FIG. 5 is a diagram of user interfaces used in the processes of FIG. 3, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing a framework for generating recommendation models are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

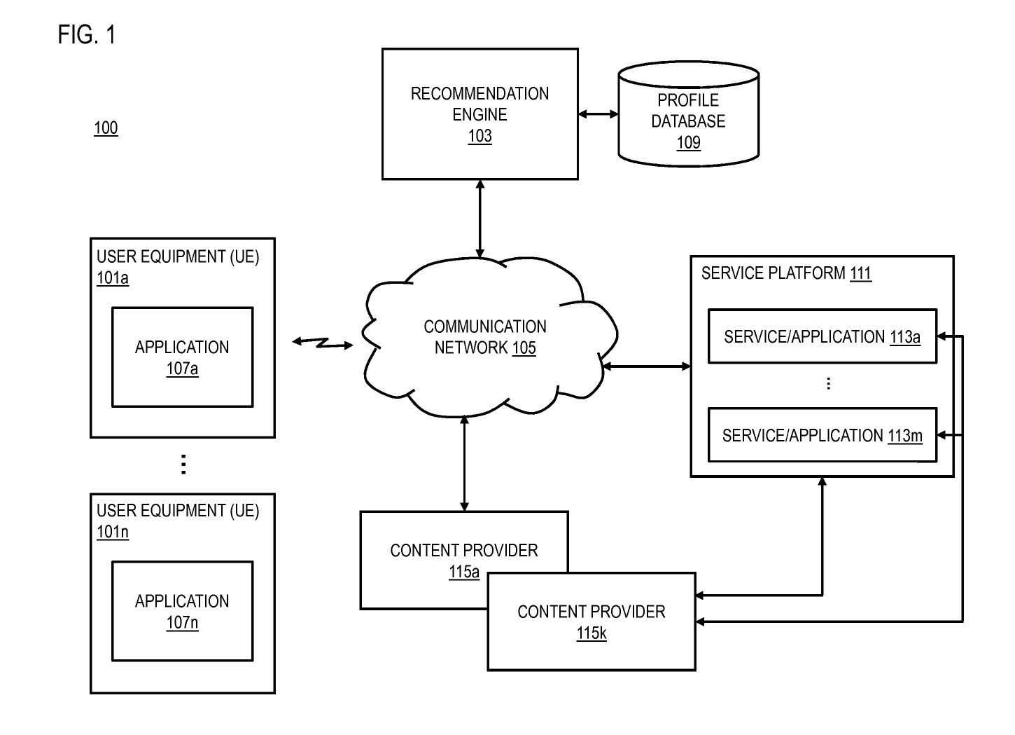

FIG. 1 is a diagram of a system capable of providing a framework for generating recommendation models, according to one embodiment. As previously mentioned, recommendation systems provide users with a number of advantages over traditional methods of search in that recommendation systems not only circumvent the time and effort of searching for items of interest, but they may also help users discover items that the users may not have found themselves. However, recommendation systems can be very complex due to the number of variables, functions, and data that are used to create models for generating recommendations. By way of example, a recommendation system for a particular application may take into consideration variables such as items viewed, item viewing times, items searched, items downloaded/uploaded, items purchased, items added to a wish list, shopping cart, or favorites list, items rated and how they were rated, etc. A recommendation system may also include as many as a hundred or more different algorithmic approaches to model and/or produce a single prediction. Nevertheless, even when the numerous variables and functions have been satisfied, a recommendation system generally still requires sufficient data (e.g., item data, user data, etc.) to effectively seed its models to produce user suggestions. Because of insufficient resources and time constraints, many applications are developed without a system that can provide user suggestions or recommendations with respect to items that may be of interest to the users. In addition, a common problem in many recommendation systems is the lack of data (e.g., item data, user data, etc.). Recommendation systems typically do not make accurate inferences about users or items for which it has not yet gathered enough data.

To address this problem, a system 100 of FIG. 1 introduces the capability to provide a common recommendation framework for use by corresponding applications, such as programs, services, or the like. More specifically, the system 100 can provide a recommendation engine that is applicable to a plurality of applications or services, for instance, through the use of a schema (or schemas) (e.g., outlines, templates, rules, definitions, etc.) for collecting and sharing information among the applications to support generation of recommendation models. In one embodiment, the system 100 can use the schema for the purpose of specifying a format for content rating information. As used herein, rating information refers to data indicating how a user has rated an item within a particular application. In one embodiment, the rating information may be explicitly provided (e.g., by specifying a number stars for a music track, thumbs up for a movie, etc.) or implicitly determined (e.g., based length of time an application item is used or accessed, frequency of use, etc.). The rating information collected from the various applications can then be pooled, associated, etc. based on the schema discussed above. In this way, the system 100 may collect the content rating information from one or more applications based on the schema for use in generating recommendation models for any of the participating applications, thereby maximizing the pool of available data (e.g., rating information) when compared to collecting information from only one application to support a standalone recommendation model.

In certain embodiments, the system 100 enables application developers to extend the schema to include new types of rating information. For example, if the schema is defined using a structured language (e.g., eXtensible Markup Language (XML)), an application developer may extend the schema by adding a new namespace to represent the new type of rating information. Accordingly, if one application cannot resolve or does not understand the new namespace, the namespace can be ignored. In addition or alternatively, if no schema is available to relate rating information collected from multiple applications, the system 100 can apply, for instance, a semantic analysis to infer the relationships between one set of rating information to another set. For example, rating information for a music application may include ratings or terms that can be semantically linked to rating information for an e-book application. In this way, if the system 100 has collected rating information from both types of applications, the collective set of rating information can still be semantically linked to enable the collective to support the generation of recommendation models for the respective applications or a new application such as recommending e-books or music according to collected data under the common framework of the system 100.

As previously discussed, the collected rating information may be stored, for instance, in one or more profiles (e.g., profiles associated with users and/or application items) for later use by any of the participating applications. A recommendation system (such as collaborative recommendation system) requires a recommendation model to provide recommendations. For example, the system 100 may receive a request to generate a recommendation model from a particular application and then may use the rating information from the one or more profiles to generate the requested recommendation model. In a further embodiment, the system 100 may extract data from the rating information collected from multiple applications based on a relevance of the data to the requesting application. The extracted data is then utilized in generating the content recommendation model for the requesting application. As such, applications may request recommendations models from the common framework or recommendation engine of the system 100 rather developing a separate recommendation framework or engine for each individual application. In this way, the system 100 advantageously enables sharing of the recommendation engine to reduce the computation, memory, bandwidth, storage, and other resource burdens associated with developing application specific recommendation models. Furthermore, the system may provide complementary data for the requesting application that would not have been possible if the application were to collect the data on its own.

In addition to improving efficiency by using a common framework for generating recommendation models for multiple applications, the common framework of the system 100 enables the information collected from one or more applications to be used to generate a recommendation model for another application. For example, some subsets of data in the content rating information may be relevant to a particular application and not other applications, while other subsets are relevant to the other applications, but not the particular application. Thus, the content rating information may support the generation of a plurality of content recommendation models for a plurality of applications. Furthermore, the same content recommendation models may be reused in such an environment where the models are applicable to a plurality of applications. A circumstance where a previously generated content recommendation model for an application may be provided to other applications is, for instance, where there is some relationship between the application and the other applications that would indicate similar items and users (e.g., a jazz music blog and a jazz music store program).

More specifically, the system 100 may receive a request, at a recommendation engine, for generating a content recommendation model for an application, wherein the recommendation engine is applicable to a plurality of applications. The request may be received from or transmitted by the application for which the content recommendation model is to be generated. Moreover, the request may be made by one or more users (e.g., administrators, developers, regular users, etc.) of the application, for instance, to improve the recommendations produced by the application. The system 100 may then retrieve content rating information from one or more profiles associated with the application, one or more other applications, or a combination thereof. The system 100 may further generate the content recommendation model based on the content rating information.

As shown in FIG. 1, the system 100 comprises a user equipment (UE) 101 or multiple UEs 101a-101n (or UEs 101) having connectivity to a recommendation engine 103 via a communication network 105. A UE 101 may include or have access to an application 107 (or applications 107), which may comprise of client programs, services, or the like that may utilize a system to provide recommendations to users. As users utilize the applications 107 on their respective UEs 101, the recommendation engine 103 may collect content rating information (e.g., data indicating how a user might rate an item) from the applications 107. By way of example, content rating information collection might include asking a user to rate an item on a scale of one through ten, asking a user to create a list of items that the user likes, observing items that the user views, obtaining a list of items that the user purchases, analyzing the user's viewing times of particular items, etc. Likewise, the recommendation engine 103 may also provide the applications 107 with content recommendation models based on the content rating information that the applications 107 may utilize to produce intelligent recommendations to its users. As such, the recommendation engine 103 may include or be connected to a profile database 109 in order to access or store content rating information. Within the profile database 109, the content rating information may be stored or associated with, for instance, one or more respective user profiles. It is noted, however, that the profile database 109 may also contain other profile types, such as application profiles, item profiles, etc.

As shown, the UEs 101 and the recommendation engine 103 also have connectivity to a service platform 111 hosting one or more respective services/applications 113a-113m (also collectively referred to as services/applications 113), and content providers 115a-115k (also collectively referred to as content providers 115). In one embodiment, the services/applications 113a-113m comprise the server-side components corresponding to the applications 107a-107n operating within the UEs 101. In one embodiment, the service platform 111, the services/applications 113a-113m, the application 107a-107n, or a combination thereof have access to, provide, deliver, etc. one or more items associated with the content providers 115a-115k. In other words, content and/or items are delivered from the content providers 115a-115k to the applications 107a-107n or the UEs 101 through the service platform 111 and/or the services/applications 113a-113n.

In some cases, a developer of the services/applications 113a-113m and/or the applications 107a-107n may request that the recommendation engine 103 generate one or more recommendation models with respect to content or items obtained from the content providers 115a-115k. The developer may, for instance, transmit the request on behalf of the application 107 and/or the services/applications 113 to the recommendation engine 103 for the purpose of generating a recommendation model and/or populating the recommendation model with sufficient data in order for the application to provide user recommendations. After receiving the request for the recommendation model, the recommendation engine 103 may then retrieve content rating information from one or more profiles associated with the application 107, the services/applications 113, one or more other applications, or a combination thereof. The recommendation engine 103 may further generate the content recommendation model based on the content rating information. Because the content rating information may be derived from the one or more profiles associated with the application 107, the services/applications 113 and/or the one or more other applications, the generation of the content recommendation model is not limited only to profiles associated with the application 107 for which the generation request was made. Thus, even if the application 107 has few or no users, prior to the generation request, the recommendation engine 103 may still be able to generate a content recommendation model with enough data to produce accurate predictions with respect to suggesting items of interest to users.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, a subset of the content rating information may be extracted based on a relevance to the application. In a further embodiment, the generation of the content recommendation model may also be based on the subset extracted from the content rating information. In one sample use case, a movie streaming application may make a request for a content recommendation model to provide its users with recommendations. The relevant subset that may be extracted from the content rating information may include all data associated with movies or films from the one or more profiles located, for instance, in the profile database 109. As a result, the application may not only obtain user profile information (e.g., user preferences) associated with films previously identified by the application, but also user profile information associated with films that were not known by the application prior to its request. If, for instance, the content recommendation model generated for the application indicates that many of its users would be interested in certain previously unknown movie titles, the application may automatically search and obtain these previously unknown movies. Accordingly, the application may recommend to its users these and other available movies based on the content recommendation model constructed from the relevant subset of the content rating information.

In another embodiment, a schema is determined for specifying the content rating information across multiple applications (e.g., applications 107, services/applications 113). The schema may be used to determine, for instance, the format or structure of the content rating information. By way of example, the schema may define elements and attributes that may appear in the content rating information, the order and number of element types, data types for elements and attributes, default or fixed values for elements and attributes, etc. Elements defined by the schema may include application classifications, item categories, rating types, users, relationships, etc. In one sample use case, a basic or a skeleton schema for specifying the content rating information may be predefined. However, application developers may be able to extend the basic or skeleton schema, for instance, by providing a new namespace. In yet another embodiment, the content rating information is collected from the application, the one or more other applications, or a combination thereof based on the schema. In a further embodiment, the collected content rating information is also stored based on the schema. In this way, the operations of the recommendation engine 103 are generally made more efficient. For example, the recommendation engine 103 may access data (e.g., the content rating information) in the profile database 109 to generate new content recommendation models for any application without first having to figure out how to interpret the data since the schema is already provided.

In another embodiment, the collected content rating information is aggregated in respective ones of the one or more profiles. As provided, the one or more profiles may include one or more user profiles. It is noted, however, that the profile database 109 may also contain other profile types, such as application profiles, item profiles, etc. By way of example, user profiles in the profile database 109 may include names, locations, age, gender, race/ethnicity, nationality, items viewed, item viewing times, items searched, items downloaded/uploaded, items purchased, items added to a wish list, shopping cart, or favorites list, items rated and how they were rated, etc. Accordingly, the one of more profiles may be accessed to provide the content rating information to generate content recommendation models for one or more applications.

In another embodiment, one or more relationships between a first portion of the content rating information associated with the application and a second portion of the content rating information associated with at least one of the one or more other applications is determined. In yet another embodiment, the generation of the content recommendation model is further based on the one or more relationships. In one sample use case, the content rating information may contain data associated with a movie streaming service and also data associated with an e-reader program. The recommendation engine 103, for instance, may determine that a relationship exists between data associated with the romance genre of the movie streaming service and data associated with the romance genre of the e-reader program. As a result, the content recommendation model generated based on the romance genre relationship may indicate, for instance, that users that like e-books and romance movies have similar interests as users that like movies and romance e-books. In a further embodiment, the determination of the one or more relationships is based on the schema, a semantic analysis of the content rating information, or a combination thereof. By way of example, the determination of the relationships may be based on the schema if the relationships are defined in the schema, based on the semantic analysis if the relationships are absent from the schema, or based on both if some relationships are defined and others relationships are not.

In another embodiment, a previously generated content recommendation model may be determined to at least partially satisfy the request. In one sample use case, a content recommendation model may have been previously generated for a music website targeted for a particular music genre, such as jazz music blog. Thereafter, a request is received, at the recommendation engine 103, for generating a content recommendation model for a jazz music program that enables users to sample and buy jazz music. Although the jazz music blog may not directly provide its users with the ability to sample and purchase music, the content recommendation model previously generated for the blog may still satisfy the request by the jazz music program. This is particularly useful if music rating data is not available or in cases where quantity and quality of music ratings data may not satisfy generation of a music model. For example, the previously generated content recommendation model may have been constructed based on content rating information from other applications that allow users to sample and purchase jazz music. As such, the previously generated content recommendation model not only makes it possible for the blog to intelligently suggest links for jazz music (e.g., to sample, download, or purchase jazz music) and/or related blogs, but it also may allow the program to accurately predict and offer jazz music of interest to its users. Thus, in a further embodiment, the previously generated content recommendation model may be provided in response to the request. In this way, system resources may be reserved for the generation of content recommendation models for other applications or for other operations, such as collecting, storing, or accessing content rating information from one or more other applications.

In another embodiment, the content recommendation model is updated based on a predetermined frequency, a predetermined schedule, a detection of one or more updates to the content rating information, or a combination thereof. It is noted that content recommendation model updates may be desired in many cases, but also necessary to continue to offer useful suggestions in other cases. For example, content recommendation model updates may be required when trends change. As such, past behavior of users may no longer be helpful in making accurate predictions. Thus, in a further embodiment, rating indications in the content rating information may contain timestamps. In this way, old data may be filtered out from the content rating information when generating content recommendation models for particular applications where, for instance, user trends have changed for those applications.

In another embodiment, the content recommendation model defines a matrix for predicting an anticipated rating for one or more items of the application relative to the one or more profiles. By way of example, the content recommendation model may define a user vs. item matrix, wherein the matrix indicates how each user might rate a particular item. The indications may be expressed, for instance, by a numerical value after each user profile variable (e.g., items viewed, item viewing times, items searched, items downloaded/uploaded, items purchased, items added to a wish list, shopping cart, or favorites list, items rated and how they were rated, etc.) has been computed after being assigned a determined weight based on the application and/or other criteria. The matrix may also provide the indications simply by presenting the variables to the application. In this way, the application may assign weights to each variable and compute how each user might rate the items based on the assigned variable weights.

In some embodiments, the recommendation model and/or the matrix may be generated based, at least in part, on one or more additional parameters specified by the requesting service, the recommendation engine 103, and/or another component of the system 100. For example, in one embodiment, the recommendation engine 103 can create a factorized recommendation model (e.g., in the case of a matrix factorization approach to collaborative filters for generating recommendations). A parameter used to create the factorized recommendation model is, for instance, the number of latent topics to include that would be used to model each matrix (e.g., user matrix, item matrix). This parameter (i.e., the number of latent topics) can either be determined by the recommendation engine 103 (e.g., if the information is available to the recommendation engine 103), provided by the requesting application or service as input parameters is its request to generate a recommendation engine, or a combination thereof. It is noted that the parameters are often dependent on the nature of the applications, service, items, etc. relevant to service and are often specific to a particular recommendation model.

In another embodiment, the content rating information supports generation of a plurality of content recommendation models. As provided, there are many instances where the content rating information may support the generation of a plurality of content recommendation models. In one sample use case, a movie streaming service may make a request for a content recommendation model to provide its users with recommendations. The recommendation engine 103 may extract a subset of the content rating information retrieved from the one or more profiles in the profile database 109 based on a relevance to the movie streaming service, such as data associated with movies. However, the retrieved content rating information may also contain subsets that are not pertinent to the movie streaming service, but may be applicable to other unrelated applications, such as an e-reader program, a dating service, or a vacation blog. Accordingly, the different subsets of the content rating information may support the generation of more than one content recommendation model.

By way of example, the UE 101, the recommendation engine 103, and the application 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the corresponding service platform 111, services 113a-113m, the content providers 115a-115k, or a combination thereof interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

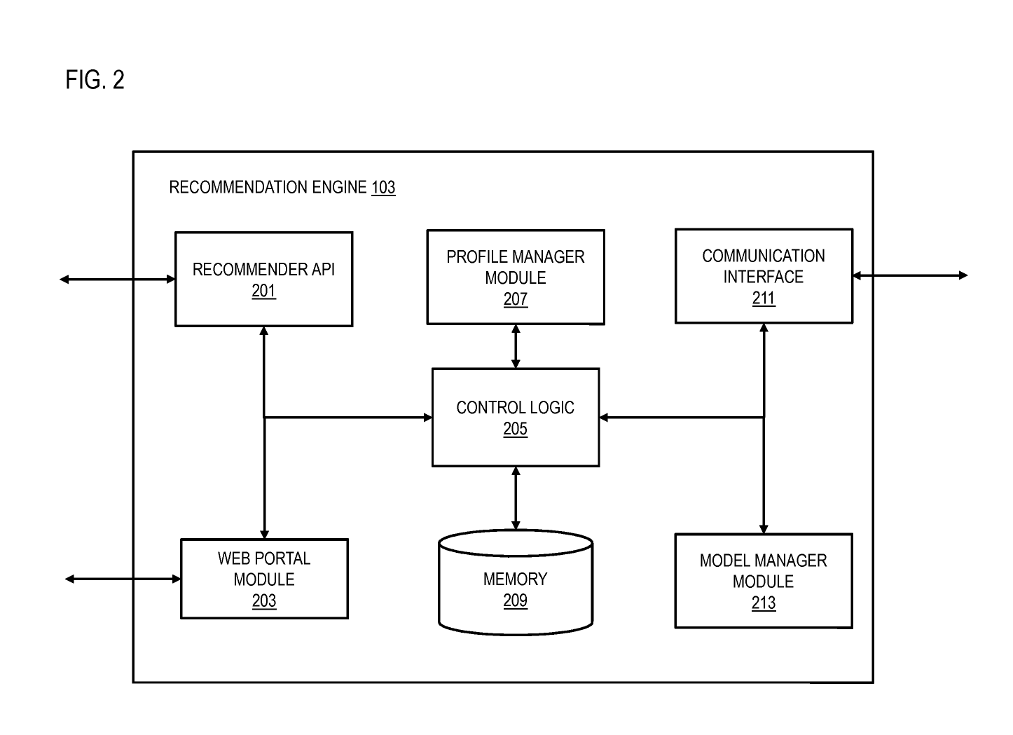

FIG. 2 is a diagram of the components of a recommendation engine, according to one embodiment. By way of example, the recommendation engine 103 includes one or more components for providing a framework for generating recommendation models. It is contemplated that the functions of these components may be combined in one or more components or performed by other components of equivalent functionality. In this embodiment, the recommendation engine 103 includes a recommendation API 201, a web portal module 203, control logic 205, a memory 209, a communication interface 211, and a model manager module 213.

The control logic 205 can be utilized in controlling the execution of modules and interfaces of the recommendation engine 103. The program modules can be stored in the memory 209 while executing. The communication interface 211 can be utilized to interact with UEs 101 (e.g., via a communication network 105). Further, the control logic 205 may utilize the recommendation API 201 (e.g., in conjunction with the communication interface 211) to interact with applications 107, the service platform 111, the services/applications 113, other applications, platforms, and/or the like.

The communication interface 211 may include multiple means of communication. For example, the communication interface 211 may be able to communicate over SMS, internet protocol, instant messaging, voice sessions (e.g., via a phone network), or other types of communication. The communication interface 211 can be used by the control logic 205 to communicate with the UEs 101a-101n, and other devices. In some examples, the communication interface 211 is used to transmit and receive information using protocols and methods associated with the recommendation API 201.

By way of example, the web portal module 203 may be utilized to facilitate access to modules or components of the recommendation engine 103, for instance, by developers. Accordingly, the web portal module 203 may generate a webpage and/or a web access API to enable developers to test or register their applications with the recommendation engine 103. Developer may further utilize the web page and/or the web access API to transmit a request to recommendation engine 103 for the generation of content recommendation models for their applications.

Moreover, the profile manager module 207 may manage, store, or access data in the profile database 109. As such, the profile manager module 207 may determine how data from the content rating information should be stored or accessed (e.g., based on a schema). In addition, the model manager module 213 may handle the generation of content recommendation models. Thus, the model manager module 213 may interact with the profile manager module 207, via the control logic 205, to obtain the content rating information in order to generate the content recommendation models. As such, the model manager module 213 may further act as a filter in generating the content recommendation models from the content rating information such that data that does not meet certain criteria, such as relevance to a particular application, is not utilized in generating the content recommendation models.

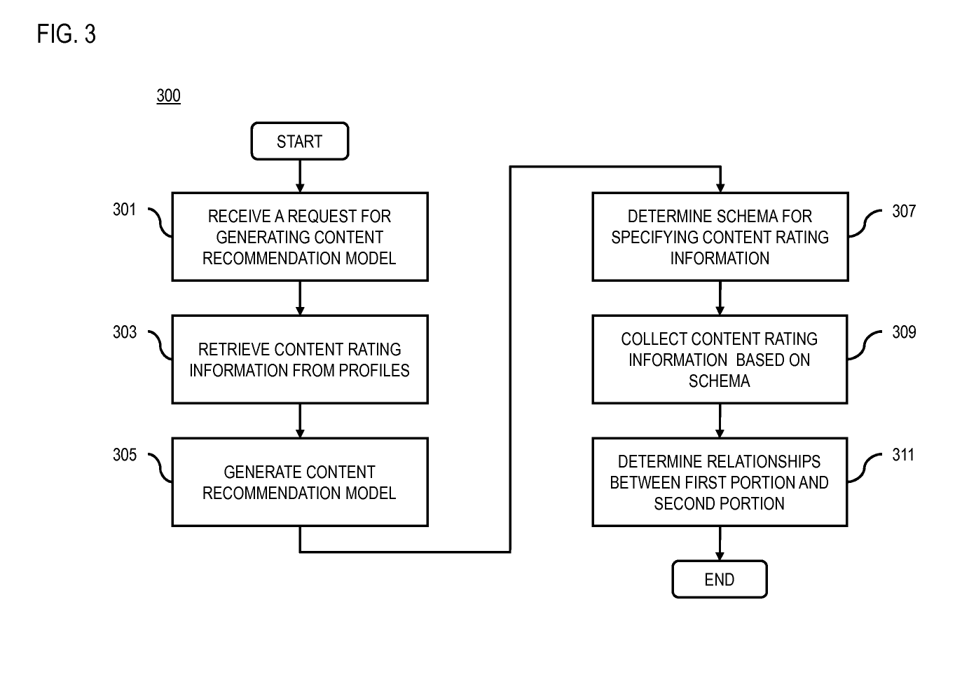

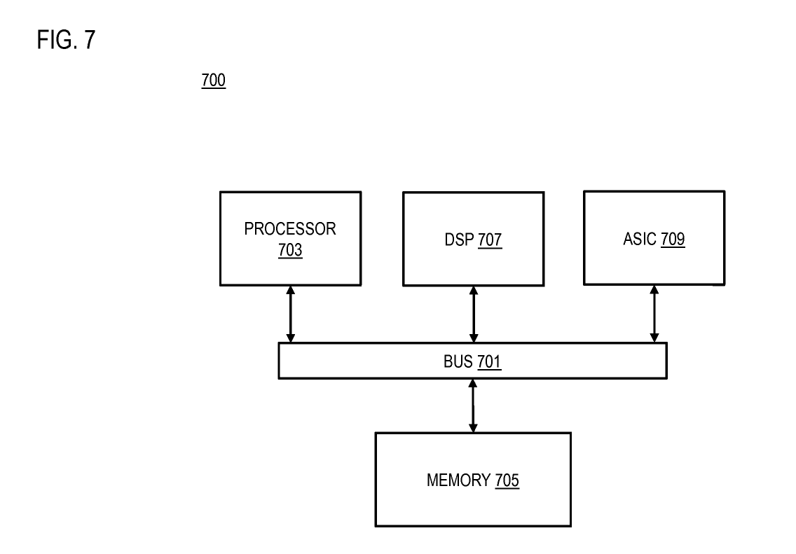

FIG. 3 is a flowchart of a process for providing a framework for generating recommendation models, according to one embodiment. In one embodiment, the recommendation engine 103 performs the process 300 and is implemented in, for instance, a chip set including a processor and a memory as shown in FIG. 7. As such, the control logic 205 can provide means for accomplishing various parts of the process 300 as well as means for accomplishing other processes in conjunction with other components of the recommendation engine 103.

In step 301, the control logic 205 receives a request, at the recommendation engine 103, for generating a content recommendation model for an application, wherein the recommendation engine 103 is applicable to a plurality of applications. As suggested, the request may be received from or transmitted by the application for which the content recommendation model is to be generated. In addition, the request may also be transmitted by one or more users, such as a developer, to generate, for instance, a content recommendation model for the application for the first time.

In step 303, the control logic 205 determines to retrieve content rating information from one or more profiles associated with the application, one or more other applications, or a combination thereof. Further, in step 305, the control logic 205 determines to generate the content recommendation model based, at least in part, on the content rating information. In this way, the generation of the content recommendation model is not limited only to profiles associated with the application for which the generation request was made. Thus, the application is able to take advantage of the data collected from the one more other applications to populate its content recommendation model such that the application is enabled to produce intelligent recommendations for its users.

In step 307, the control logic 205 determines a schema for specifying the content rating information. As previously mentioned, the recommendation engine 103 may provide the schema for specifying the content. Moreover, the schema offered by the recommendation engine 103 may only be a base schema, such that application developers may be able to extend the base schema, for instance, by adding a new namespace. As such, in step 309, the control logic 205 determines to collect the content rating information from the application, the one or more other applications, or a combination thereof based, at least in part, on the schema. The control logic 205 may further determine to store the collected content rating information, for instance, in the profile database 109 based, at least in part, on the schema. In this way, operations of the recommendation engine 103 may be made more efficient. For example, because the schema is already determined, the recommendation engine 103 may retrieve the content rating information from the one or more profiles without first having to figure out how to decipher the retrieved data. Moreover, because the content rating information is specified according to the schema, some attributes, such as relationships between portions of the content rating information, may already be laid out neatly in the content rating information.

In step 311, the control logic 205 determines one or more relationships between a first portion of the content rating information associated with the application and a second portion of the content rating information associated with at least one of the one or more other applications, wherein the determination to generate the content recommendation model is further based, at least in part, on the one or more relationships. The control logic 205 may further determine the one or more relationships based, at least in part, on the schema, a semantic analysis of the content rating information, or a combination thereof. By way of example, the determination of the relationships may be based on the schema if the relationships are defined in the schema, based on the semantic analysis if the relationships are absent from the schema, or based on both if some relationships are defined and others relationships are not.

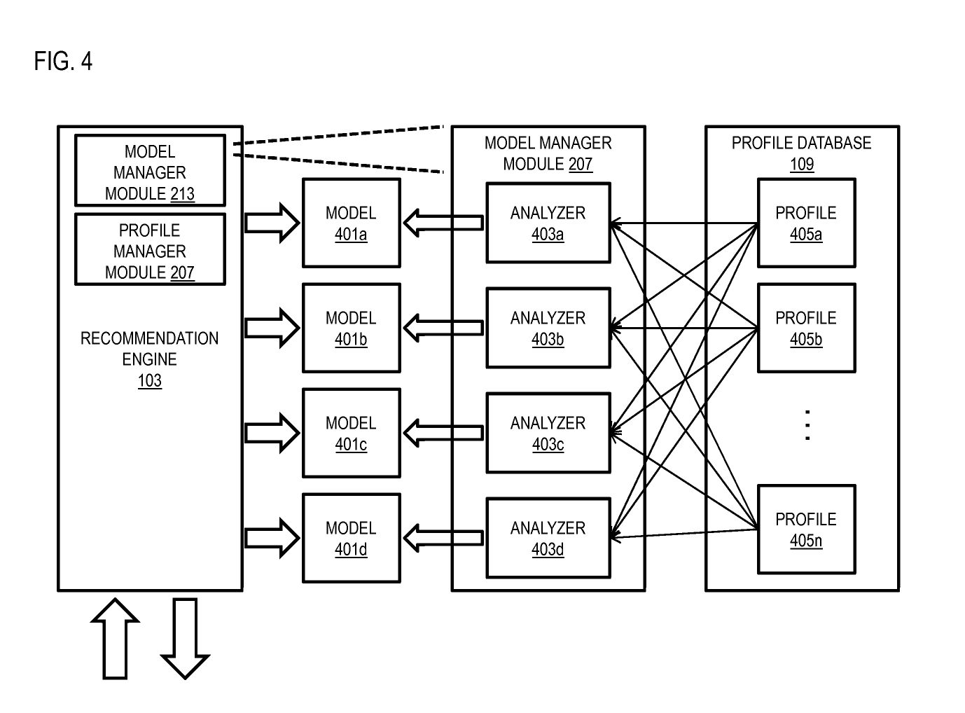

FIG. 4 is a diagram demonstrating the processes of FIG. 3, according to one embodiment. As shown, FIG. 4 presents the recommendation engine 103, the profile database 109, the profile manager module 207, the model manager module 213, models 401a-401d, analyzers 403a-403d, and profiles 405a-405n. In this diagram, the recommendation engine 103 is simultaneously in the process of generating models 401a-401d (e.g., content recommendation models) for at least four different applications. As such, the recommendation engine 103 is applicable to a plurality of applications.

By way of example, when a request is received, at the recommendation engine 103, for generating a content recommendation model for an application, the recommendation engine 103 may retrieve, via the profile manager 207, content rating information from profiles 405a-405n in the profile database 109. The profiles 405a-405n, as discussed above, may be associated with the application, one or more other applications, or a combination thereof. Thereafter, the recommendation engine 103, via the model manager 213, generates the content recommendation model based on the content rating information. During this step, the model manager 213 may filter out data that may be unnecessary for the generation of the content recommendation model using the analyzers 403a-403d. According, only a subset of the content rating information may be extracted, for instance, based on a relevance to the application for the purpose of generating the content recommendation model. In addition, the analyzers 403a-403d may determine one or more relationships between a first portion of the content rating information associated with the application and a second portion of the content rating information associated with other applications for the purpose of generating the content recommendation model. To determine the relationships, the analyzers 403a-403b may rely on the schema used to specify the content rating information and/or a semantic analysis of the content rating information. If, for example, the relationships are defined in the schema, the relationship determinations may be based on the schema. If the relationships are absent from the schema, the relationship determinations may be based on the semantic analysis. If some relationships are defined in the schema and other relationships are not, the relationship determined may be based on both the schema and the semantic analysis.

Simultaneously, the recommendation engine 103 may collect additional content rating information from the application and/or the one or more other applications based on the schema used to specify the content rating information. The recommendation engine 103, via the profile manager module 207, may then aggregate the collected content rating information in the respective profiles 405a-405n in the profile database 109.

The processes described herein for providing a framework for generating recommendation models may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

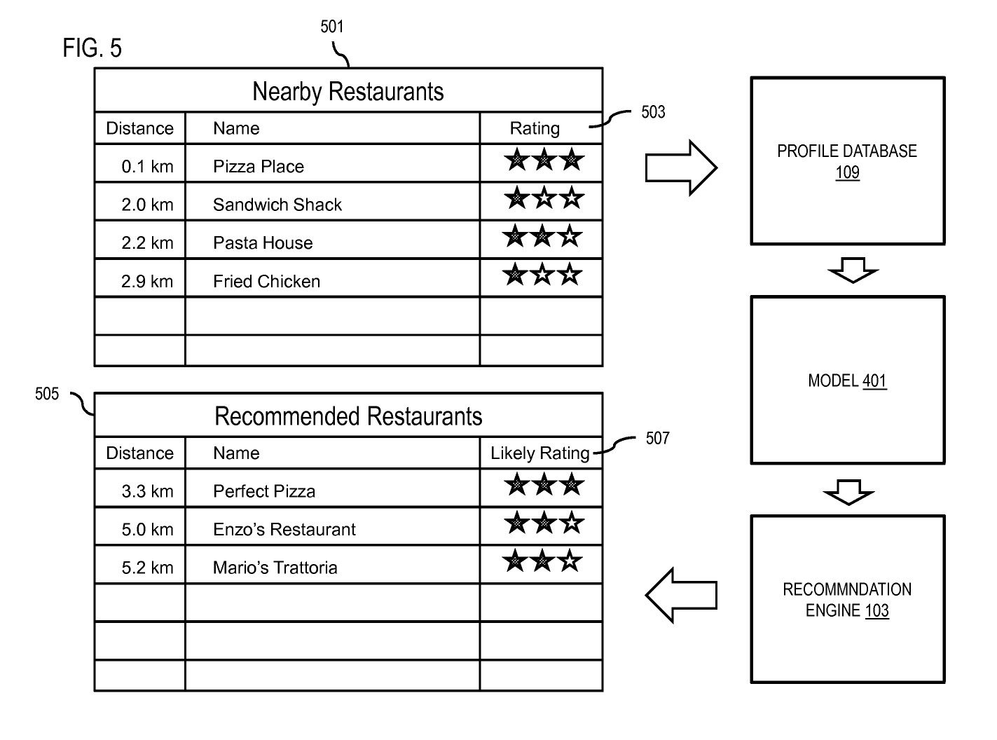

FIG. 5 is a diagram of user interfaces used in the processes of FIG. 3, according to one embodiment. More specifically, FIG. 5 depicts a user interface (UI) 501 that presents, for instance, search results for nearby restaurants generated by a mapping application. As shown, the UI 501 includes a rating column 503 in which the user may indicate or otherwise input a rating for the listed restaurants. In this example, the user specified ratings for each of the four restaurants (e.g., Pizza Place, Sandwich Shack, Pasta House, and Fried Chicken) listed in the UE 501. By way of example, the rating information may be specified using a touch-based interface to select a rating from one to three stars for each entry.

The rating information is then transmitted or otherwise conveyed and stored in the profile database 109. Next, the rating information is used, at least in part, to generate or update the recommendation model 401 according to the approach described herein. The recommendation model 401 enables the recommendation engine 103 to generate restaurant recommendations for presentation in the corresponding mapping application. For example, the UI 505 presents a list of recommended restaurants (e.g., based at least in part on the rating information specified in the UE 501 and the recommendation model 401). In the example of FIG. 5, the list of recommended restaurants includes a column 507 for listing the “likely rating” of the recommended restaurants. The “likely rating” represents, for instance, the recommendation engine 103's estimate of the ratings a particular user is likely to give to a previously unrated restaurant based on rating information previously specified by the user. In one embodiment, the user can confirm or change the “likely rating” information. On making such a change, the updated rating information can also be collected and stored in the profile database 109 for updating the recommendation model 401. It is contemplated that the rating information collection and update process can occur recursively to improve the accuracy of the recommendation model 401.

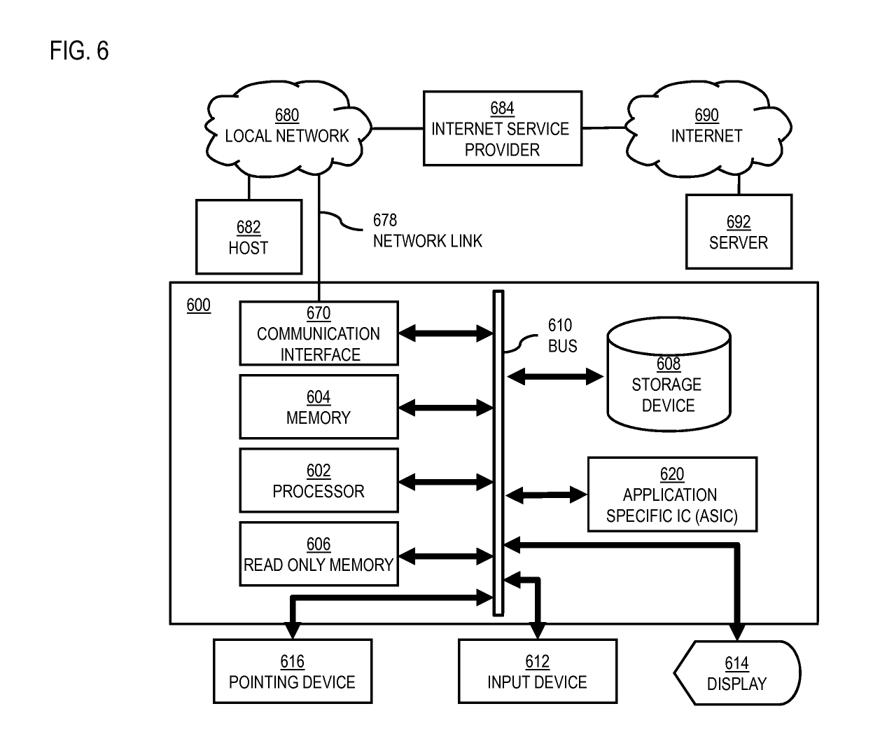

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a framework for generating recommendation models as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a framework for generating recommendation models.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing a framework for generating recommendation models. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing a framework for generating recommendation models. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a framework for generating recommendation models, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing a framework for generating recommendation models to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide a framework for generating recommendation models as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing a framework for generating recommendation models.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a framework for generating recommendation models. The memory 705 also stores the data associated with or generated by the execution of the inventive steps.

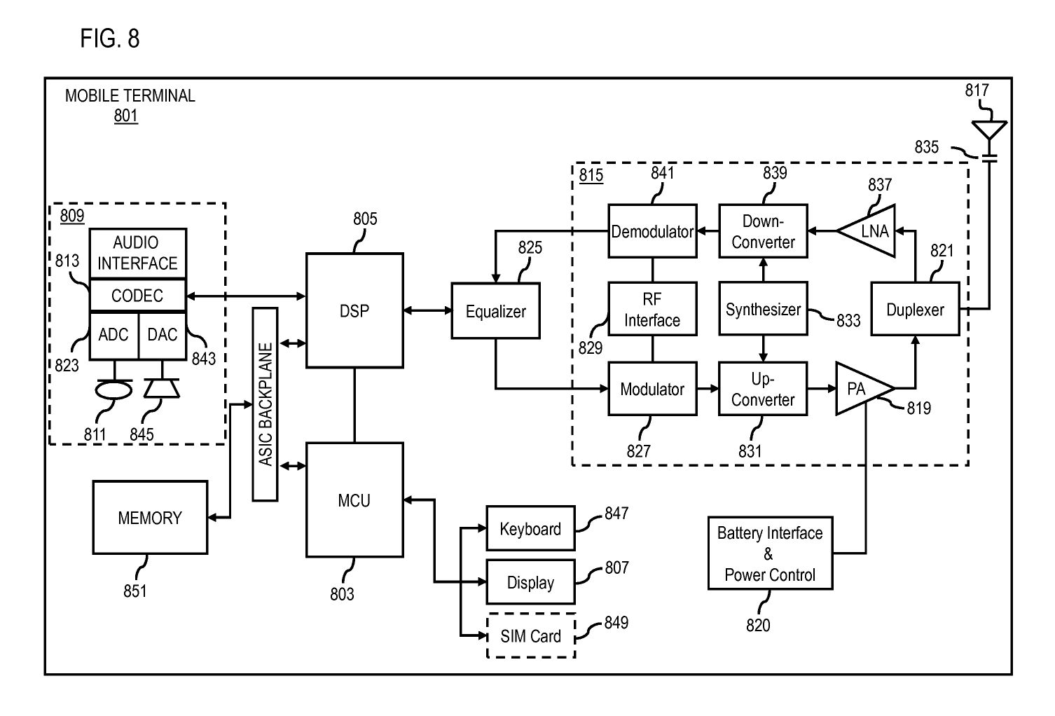

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing a framework for generating recommendation models. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a framework for generating recommendation models. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide a framework for generating recommendation models. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request, at a recommendation engine, for generating a recommendation model for an application, wherein the recommendation engine is applicable to a plurality of applications;
determining to retrieve rating information from one or more profiles associated with the application, one or more other applications, or a combination thereof; and
determining to generate the recommendation model based, at least in part, on the rating information.

2. A method of claim 1, further comprising:
determining to extract a subset of the rating information based, at least in part, on a relevance to the application,
wherein the determining to generate the recommendation model is based, at least in part, on the subset.

3. A method of claim 1, further comprising:
determining a schema for specifying the rating information; and
determining to collect the rating information from the application, the one or more other applications, or a combination thereof based, at least in part, on the schema.

4. A method of claim 3, further comprising:
determining to aggregate the collected rating information in respective ones of the one or more profiles.

5. A method of claim 3, further comprising:
determining one or more relationships between a first portion of the rating information associated with the application and a second portion of the rating information associated with at least one of the one or more other applications,
wherein the determining to generate the recommendation model is further based, at least in part, on the one or more relationships.

6. A method of claim 5, wherein the determining of the one or more relationships is based, at least in part, on the schema, a semantic analysis of the rating information, or a combination thereof.

7. A method of claim 1, further comprising:
determining that a previously generated recommendation model at least partially satisfies the request; and
providing the previously generated recommendation model in response to the request.

8. A method of claim 1, wherein the recommendation model defines a matrix for predicting an anticipated rating for one or more items of the application relative to the one or more profiles.

9. A method of claim 1, wherein the rating information supports generation of a plurality of recommendation models.

10. A method of claim 1, further comprising:
determining to update the recommendation model based, at least in part, on a predetermined frequency, a predetermined schedule, a detection of one or more updates to the rating information, or a combination thereof.

11. An apparatus comprising:
at least one processor; and
at least one memory including computer program code for one or more programs,
the at least one memory and the computer program code configured to, with the at least one processor, cause the apparatus to perform at least the following,
receive a request, at a recommendation engine, for generating a recommendation model for an application, wherein the recommendation engine is applicable to a plurality of applications;
determine to retrieve rating information from one or more profiles associated with the application, one or more other applications, or a combination thereof; and
determine to generate the recommendation model based, at least in part, on the rating information.

12. An apparatus of claim 11, wherein the apparatus is further caused to:
determine to extract a subset of the rating information based, at least in part, on a relevance to the application,
wherein the determination to generate the recommendation model is based, at least in part, on the subset.

13. An apparatus of claim 11, wherein the apparatus is further caused to:
determine a schema for specifying the rating information; and
determine to collect the rating information from the application, the one or more other applications, or a combination thereof based, at least in part, on the schema.

14. An apparatus of claim 13, wherein the apparatus is further caused to:
determining to aggregate the collected rating information in respective ones of the one or more profiles.

15. An apparatus of claim 13, wherein the apparatus is further caused to:
determine one or more relationships between a first portion of the rating information associated with the application and a second portion of the rating information associated with at least one of the one or more other applications,
wherein the determination to generate the recommendation model is further based, at least in part, on the one or more relationships.

16. An apparatus of claim 15, wherein the determination of the one or more relationships is based, at least in part, on the schema, a semantic analysis of the rating information, or a combination thereof.

17. An apparatus of claim 11, wherein the apparatus is further caused to:
determine that a previously generated recommendation model at least partially satisfies the request; and
provide the previously generated recommendation model in response to the request.

18. An apparatus of claim 11, wherein the recommendation model defines a matrix for predicting an anticipated rating for one or more items of the application relative to the one or more profiles.

19. An apparatus of claim 11, wherein the rating information supports generation of a plurality of recommendation models.

20. An apparatus of claim 11, wherein the apparatus is further caused to:
determine to update the recommendation model based, at least in part, on a predetermined frequency, a predetermined schedule, a detection of one or more updates to the rating information, or a combination thereof.

21.-43. (canceled)
